(19) United States
(12) Patent Application Publication
(10) Pub. No.: US 2023/0381715 A1
(43) Pub. Date: Nov. 30, 2023

(54) CARBON DIOXIDE RECOVERY SYSTEM

(71) Applicant: DENSO CORPORATION, Kariya-city (JP)

(72) Inventors: Hiroki TAKEZAKI, Kariya-city (JP); Hiroaki UMEDA, Kariya-city (JP); Hironori TATSUMI, Kariya-city (JP)

(21) Appl. No.: 18/318,757

(22) Filed: May 17, 2023

(30) Foreign Application Priority Data
May 24, 2022 (JP) 2022-084575

(51) Int. Cl. B01D 53/32; B01D 53/04

(52) U.S. Cl. CPC B01D 53/326; B01D 53/04; B01D 2253/204; B01D 2256/22; B01D 2257/504; B01D 2255/1021; B01D 2255/1026; B01D 2255/402; B01D 2255/806; B01D 2255/1028; B01D 2255/2073

(57) ABSTRACT

A carbon dioxide recovery system separates CO₂ from gas containing CO₂ via an electrochemical reaction. The carbon dioxide recovery system includes an electrochemical cell including a working electrode and a counter electrode. The working electrode includes CO₂ adsorbent. The CO₂ adsorbent adsorbs CO₂ via an oxygen reduction reaction by using electrons supplied from the counter electrode to the working electrode when a first voltage is applied between the working electrode and the counter electrode. The oxygen reduction reaction produces active oxygen via reduction of O₂. The CO₂ adsorbent desorbs CO₂ by discharging electrons from the working electrode to the counter electrode when a second voltage different from the first voltage is applied between the working electrode and the counter electrode. The CO₂ adsorbent has a promoting function for promoting the oxygen reduction reaction.

### CROSS REFERENCE TO RELATED APPLICATION

The present application is based on Japanese Patent Application No. 2022-084575 filed on May 24, 2022, the entire disclosure of which is incorporated herein by reference.

### TECHNICAL FIELD

The present disclosure relates to a carbon dioxide recovery system that recovers CO₂ from a CO₂-containing gas.

### BACKGROUND

A method separates CO₂ from a CO₂-containing gas by an electrochemical reaction.

### SUMMARY

According to at least one embodiment, a carbon dioxide recovery system separates CO₂ from gas containing CO₂ via an electrochemical reaction. The carbon dioxide recovery system includes an electrochemical cell including a working electrode and a counter electrode. The working electrode includes CO₂ adsorbent. The CO₂ adsorbent is configured to adsorb CO₂ via an oxygen reduction reaction by using electrons supplied from the counter electrode to the working electrode when a first voltage is applied between the working electrode and the counter electrode. The oxygen reduction reaction produces active oxygen via reduction of O₂. The CO₂ adsorbent is configured to desorb CO₂ by discharging electrons from the working electrode to the counter electrode when a second voltage different from the first voltage is applied between the working electrode and the counter electrode. The CO₂ adsorbent has a promoting function for promoting the oxygen reduction reaction.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating a carbon dioxide recovery system of a first embodiment.

FIG. 2 is a diagram illustrating a CO₂ recovery device.

FIG. 3 is a cross-sectional view of an electrochemical cell.

FIG. 4 is a diagram for explaining activation energy of an oxygen reduction reaction when an oxygen reduction catalyst is used.

FIG. 5 is a diagram for explaining the activation energy of a carbonate ion dissociation reaction when a carbonate ion dissociation catalyst is used.

FIG. 6 is a diagram for explaining a CO₂ recovery mode and a CO₂ discharge mode of the CO₂ recovery device.

### DETAILED DESCRIPTION

To begin with, examples of relevant techniques will be described.

A comparative example is a method for separating CO₂ from a CO₂-containing gas by an electrochemical reaction. In this method, the CO₂-containing gas is supplied to a cathode of an electrochemical cell while a potential difference is applied between the cathode and an anode. As a result, an electrochemical reaction producing CO₃²⁻ from CO₂ and an electrochemical reaction producing CO₂ from CO₃²⁻ are performed.

However, the electrochemical reaction producing CO₃²⁻ from CO₂ and the electrochemical reaction producing CO₂ from CO₃²⁻ require a large amount of electrical energy to proceed these electrochemical reactions. Therefore, when CO₂ is recovered from the CO₂-containing gas by the electrochemical reaction producing CO₃²⁻ from CO₂ and the electrochemical reaction producing CO₂ from CO₃²⁻, a CO₂ recovery efficiency is decreased.

In contrast to the comparative example, according to a carbon dioxide recovery system of the present disclosure, a CO₂ recovery efficiency can be improved.

According to one aspect of the present disclosure, a carbon dioxide recovery system separates CO₂ from gas containing CO₂ via an electrochemical reaction. The carbon dioxide recovery system includes an electrochemical cell including a working electrode and a counter electrode. The working electrode includes CO₂ adsorbent. The CO₂ adsorbent is configured to adsorb CO₂ via an oxygen reduction reaction by using electrons supplied from the counter electrode to the working electrode when a first voltage is applied between the working electrode and the counter electrode. The oxygen reduction reaction produces active oxygen via reduction of O₂. The CO₂ adsorbent is configured to desorb CO₂ by discharging electrons from the working electrode to the counter electrode when a second voltage different from the first voltage is applied between the working electrode and the counter electrode. The CO₂ adsorbent has a promoting function for promoting the oxygen reduction reaction.

According to this configuration, the CO₂ adsorbent is configured to adsorb the CO₂ via the oxygen reduction reaction by using electrons supplied from the counter electrode to the working electrode when the first voltage is applied between the working electrode and the counter electrode. The oxygen reduction reaction produces active oxygen via reduction of O₂. The CO₂ adsorbent has a promoting function for promoting the oxygen reduction reaction.

As a result, an electrical energy required for the oxygen reduction reaction that triggers CO₂ adsorption at the working electrode can be reduced, and a CO₂ recovery efficiency at the working electrode can be improved.

According to one aspect of the present disclosure, a carbon dioxide recovery system separates CO₂ from gas containing CO₂ via an electrochemical reaction. The carbon dioxide recovery system includes an electrochemical cell including a working electrode and a counter electrode. The working electrode includes CO₂ adsorbent. The CO₂ adsorbent is configured to adsorb CO₂ by using electrons supplied from the counter electrode to the working electrode when a first voltage is applied between the working electrode and the counter electrode. The CO₂ adsorbent is configured to desorb CO₂ via a carbonate ion dissociation reaction by discharging electrons from the working electrode to the counter electrode when a second voltage is applied between the working electrode and the counter electrode The carbonate ion dissociation reaction produces CO₂ from CO₃²⁻ via dissociation of CO₂. The CO₂ adsorbent has a promoting function for promoting the carbonate ion dissociation reaction.

According to this configuration, the CO₂ adsorbent is configured to desorb CO₂ via a carbonate ion dissociation reaction by discharging electrons from the working electrode to the counter electrode when the second voltage is applied between the working electrode and the counter electrode. The carbonate ion dissociation reaction produces CO₂ from CO₃²⁻ via dissociation of CO₂. The CO₂ adsorbent has a promoting function for promoting the carbonate ion dissociation reaction.

As a result, an electrical energy required for the carbonate ion dissociation reaction that triggers CO₂ desorption at the working electrode can be reduced, and a CO₂ recovery efficiency at the working electrode can be improved.

Hereinafter, embodiments for carrying out the present disclosure will be described with reference to the drawings. In each embodiment, the same reference numerals may be given to parts corresponding to matters described in a preceding embodiment, and overlapping explanations may be omitted. When only a part of the configuration is described in each embodiment, the previously described other embodiments can be applied to other parts of the configuration. A combination of parts is possible when it is explicitly stated that the combination is possible in each embodiment. A partial combination of the embodiments is also possible even if it is not explicitly stated that the partial combination is possible, unless there is a particular problem with the partial combination.

### First Embodiment

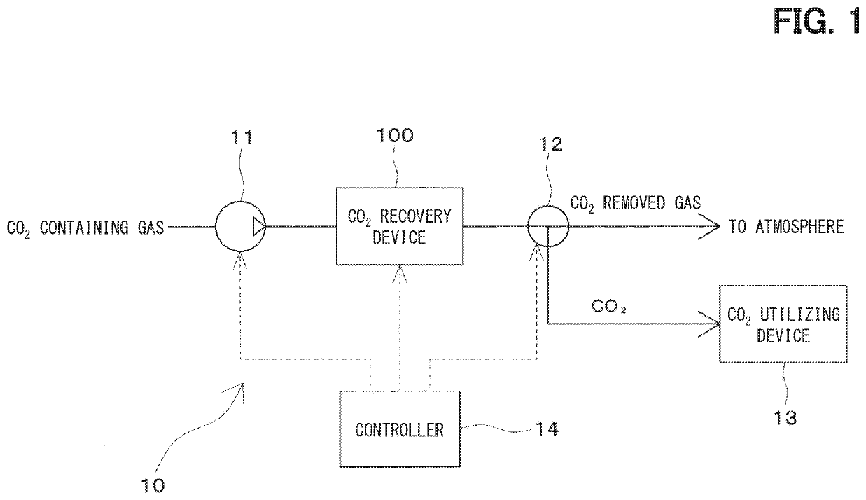

A first embodiment of the present invention will be described below with reference to the drawings. As shown in FIG. 1, a carbon dioxide recovery system 10 of the present embodiment includes a compressor 11, a CO₂ recovery device 100, a passage switching valve 12, a CO₂ utilizing device 13, and a controller 14.

The compressor 11 pumps CO₂ containing gas to the CO₂ recovery device 100. The CO₂ containing gas is a mixed gas containing CO₂ and a gas other than CO₂, and for example, ambient air can be used as the CO₂ containing gas. The CO₂-containing gas contains at least O₂ in addition to CO₂.

The CO₂ recovery device 100 is a device that separates and recovers CO₂ from the CO₂-containing gas. The CO₂ recovery device 100 discharges CO₂-removed gas that is gas after CO₂ is recovered from the CO₂-containing gas, or discharges CO₂ recovered from the CO₂ containing gas. The configuration of the CO₂ recovery device 100 will be described in detail later.

The passage switching valve 12 is a three-way valve that switches a passage of exhaust gas discharged from the CO₂ recovery device 100. The passage switching valve 12 switches the passage of the exhaust gas to lead to the atmosphere when the CO₂-removed gas is discharged from the CO₂ recovery device 100, and the passage of the exhaust gas toward the CO₂ utilizing device 13 when CO₂ is discharged from the CO₂ recovery device 100.

The CO₂ utilizing device 13 is a device that utilizes CO₂. The CO₂ utilizing device 13 may be a storage tank for storing CO₂ or a conversion device for converting CO₂ into fuel. The conversion device may be a device that converts CO₂ into a hydrocarbon fuel such as methane. The hydrocarbon fuel may be gaseous fuel at normal temperature and pressure, or may be liquid fuel at normal temperature and pressure.

The controller 14 includes a well-known microcontroller including a calculation processing device (i.e., CPU), a read only memory (i.e., ROM), a random access memory (i.e., RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the CO₂ recovery device 100, a passage switching control of the passage switching valve 12 and the like.

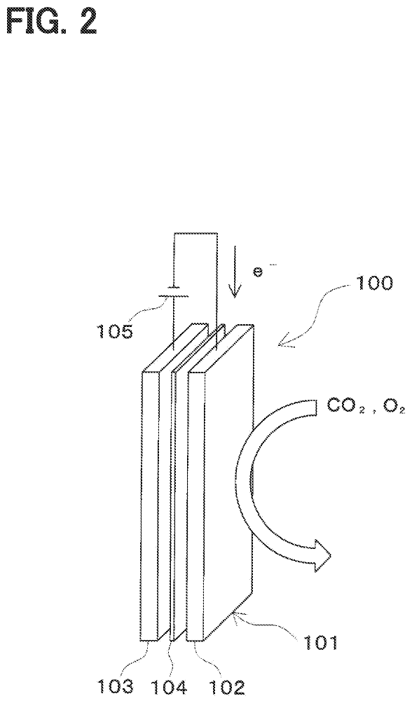

Next, the CO₂ recovery device 100 will be described with reference to FIG. 2. As shown in FIG. 2, the CO₂ recovery device 100 is provided with an electrochemical cell 101. The electrochemical cell 101 has a working electrode 102, a counter electrode 103 and an insulating layer 104. In the example shown in FIG. 2, the working electrode 102, the counter electrode 103 and the insulating layer 104 are each formed in a plate shape. In FIG. 2, the working electrode 102, the counter electrode 103 and the insulating layer 104 are illustrated to have distances between them, but actually, these components are arranged to be in contact with each other.

The electrochemical cell 101 may be housed in a container (not shown). The container may define a gas inlet for introducing the CO₂-containing gas into the container and a gas outlet for discharging the CO₂-removed gas or CO₂ out of the container.

The CO₂ recovery device 100 is configured to adsorb and desorb CO₂ via an electrochemical reaction, thereby separating and recovering CO₂ from the CO₂-containing gas. The CO₂ recovery device 100 includes a power supply 105 that applies a predetermined voltage to the working electrode 102 and the counter electrode 103, and can change a potential difference between the working electrode 102 and the counter electrode 103. The working electrode 102 is a negative electrode, and the counter electrode 103 is a positive electrode.

The electrochemical cell 101 can be switched between a CO₂ recovery mode in which CO₂ is recovered at the working electrode 102 and a CO₂ discharge mode in which CO₂ is discharged from the working electrode 102 by changing the potential difference between the working electrode 102 and the counter electrode 103. The CO₂ recovery mode is a charging mode for charging the electrochemical cell 101, and the CO₂ discharge mode is a discharging mode for discharging the electrochemical cell 101.

In the CO₂ recovery mode, a first voltage V1 is applied between the working electrode 102 and the counter electrode 103, and electrons flows from the counter electrode 103 to the working electrode 102. At the first voltage V1, the counter electrode potential is greater than the working electrode potential. The first voltage V1 may fall within a range between 0.5 and 2.0 V.

In the CO₂ discharge mode, a second voltage V2 that is lower than the first voltage V1 is applied between the working electrode 102 and the counter electrode 103, and electrons flows from the working electrode 102 to the counter electrode 103. As long as the second voltage V2 is lower than the first voltage V1, a magnitude relationship between the working electrode potential and the counter electrode potential is not limited. That is, in the CO₂ discharge mode, the counter electrode potential may be greater than, equal to or less than the working electrode potential.

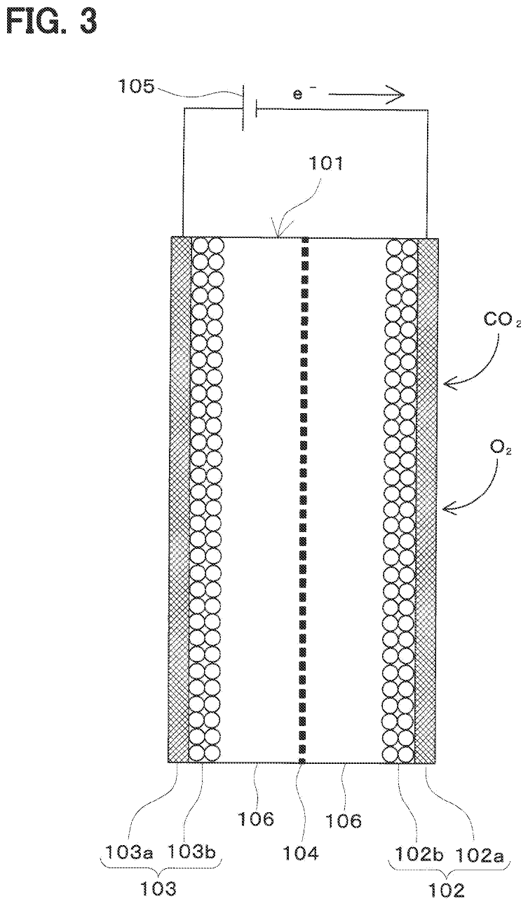

As shown in FIG. 3, the working electrode 102 is provided with a working-electrode current collector 102a and a CO₂ adsorbent 102b.

The working-electrode current collector 102a is a porous conductive material having pores through which gas containing CO₂ can pass. The working-electrode current collector 102a may be, for example, a carbonaceous material or a metal porous body. The carbonaceous material constituting the working-electrode current collector 102a may be, for example, carbon paper, carbon cloth, non-woven carbon mat, porous gas diffusion layer (GDL) and the like. The metal porous body constituting the working-electrode current collector 102a may be, for example, a metal mesh that is a metal (e.g., Al, Ni, etc.) formed into a mesh shape.

The CO₂ adsorbent 102b adsorbs CO₂ by receiving electrons, and desorbs the adsorbed CO₂ by releasing electrons. The CO₂ adsorbent 102b is a material whose chemical skeleton does not change when adsorbing CO₂.

In the present embodiment, the CO₂ adsorbent 102b is a material that can receive and release electrons without changing its chemical skeleton when a negative potential is applied to the counter electrode 103. The CO₂ adsorbent 102b is a material in which, when receiving electrons from the counter electrode 103, the electric charge is delocalized in the entire material without concentrating on a specific element in its chemical structure. In other words, the CO₂ adsorbent 102b does not have a chemical structure that serves as an active site for adsorbing CO₂.

Electrons flow from the counter electrode 103 to the working electrode 102 when the first voltage V1 is applied between the working electrode 102 and the counter electrode 103, and the CO₂ adsorbent 102b receive the electrons and adsorbs CO₂. Electrons flow from the working electrode 102 to the counter electrode 103 when the second voltage V2 is applied between the working electrode 102 and the counter electrode 103, and the CO₂ adsorbent 102b discharges the electrons and desorbs CO₂.

The CO₂ adsorbent 102b of the present embodiment contains a material having high specific surface area and conductivity. The material having the high specific surface area is a porous body having a large number of pores. The material having the high specific surface area of the CO₂ adsorbent 102b can be used as carbon electrodes, such as carbon black, graphene, carbon nanotubes, activated carbon, Ketjen black, and mesoporous carbon. In the present embodiment, the carbon black is used as the CO₂ adsorbent 102b.

In the CO₂ recovery mode, an oxygen reduction reaction shown in the following reaction formula (1) and a carbonate ion generation reaction shown in the following reaction formula (2) proceed at the working electrode 102, and CO₂ is adsorbed on the working electrode 102. In other words, the oxygen reduction reaction triggers the CO₂ adsorption at the working electrode 102.

O₂+2e⁻→O₂⁻ (1)

O₂⁻+CO₂→½O₂+CO₃²⁻ (2)

At the working electrode 102, O₂ contained in the CO₂-containing gas receives electrons and is reduced, thereby causing the oxygen reduction reaction. Superoxide O₂⁻, which is a type of active oxygen, is formed by the oxygen reduction reaction. The active oxygen O₂⁻ formed by the oxygen reduction reaction has high reactivity, and the carbonate ion generation reaction is performed in which CO₂ is oxidized to from carbonate ions CO₃²⁻, which are oxide ions of CO₂, and CO₂ is adsorbed at the working electrode 102. In other words, the active oxygen O₂⁻ formed by the oxygen reduction reaction contributes to the CO₂ adsorption at the working electrode 102.

The working electrode 102 has a promoting function for promoting the oxygen reduction reaction. In the present embodiment, an oxygen reduction catalyst that promotes the oxygen reduction reaction is added to the CO₂ adsorbent 102b. The oxygen reduction catalyst includes at least one of Pt, RuO₂ or perovskite type oxides (for example, LaNiO₃, SrFeO₃, or SrCoO₃). Pt is used as the oxygen reduction catalyst in the present embodiment. The oxygen reduction catalyst can be used as catalyst carrying carbon in which catalyst particles are carried on the CO₂ adsorbent 102b constituting the carbon carrier.

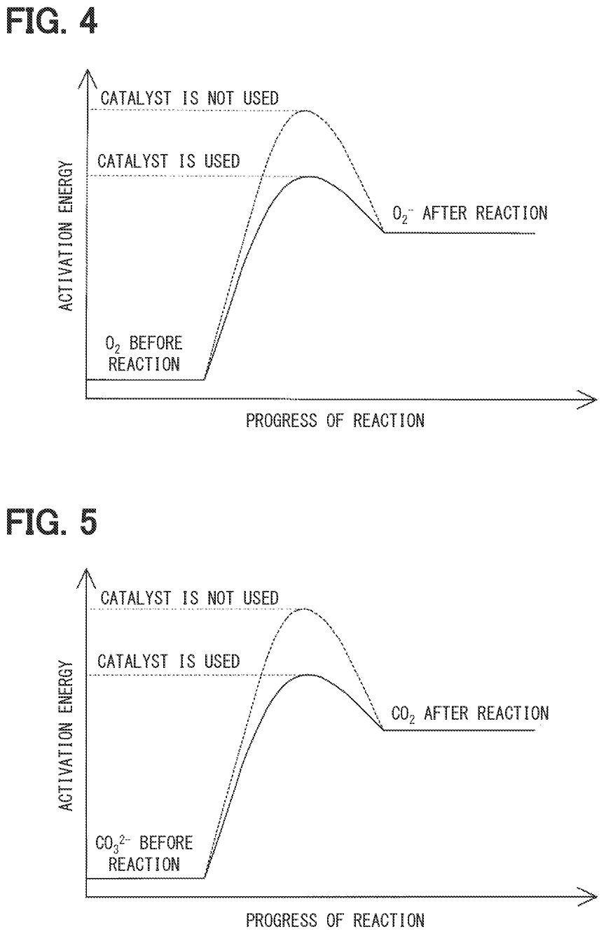

As shown in FIG. 4, when the oxygen reduction catalyst is used, activation energy required for the oxygen reduction reaction can be reduced as compared to when the oxygen reduction catalyst is not used. In other words, by using the oxygen reduction catalyst, the oxygen reduction reaction can be promoted, and the electrical energy required for the oxygen reduction reaction can be reduced.

In the CO₂ discharge mode, at least one of the carbonate ion dissociation reactions represented by the following reaction formulas (3) and (4) proceeds at the working electrode 102. In the carbonate ion dissociation reactions, the carbonate ion CO₃²⁻ is dissociated and the CO₂ is generated. In other words, the carbonate ion dissociation reactions trigger the desorption of the CO 2 at the working electrode 102.

CO₃²⁻+C→3CO₂+4e⁻ (3)

2CO₃²⁻→O₂⁻+2CO₂+4e⁻ (4)

The CO₂ adsorbent 102b of the present embodiment has the promoting function for promoting the carbonate ion dissociation reactions described above. In the present embodiment, a carbonate ion dissociation catalyst that promotes the carbonate ion dissociation reactions is added to the CO₂ adsorbent 102b. The carbonate ion dissociation catalyst includes at least one of RuO₂, IrO₂, Mn or Mn₂C. The carbon ion dissociation catalyst can be used as catalyst carrying carbon in which catalyst particles are carried on the CO₂ adsorbent 102b constituting the carbon carrier.

As shown in FIG. 5, when the carbon ion dissociation catalyst is used, activation energy required for the carbonate ion dissociation reactions can be reduced as compared to when the carbon ion dissociation catalyst is not used. In other words, by using the carbon ion dissociation catalyst, the carbonate ion dissociation reactions can be promoted, and the electrical energy required for the carbonate ion dissociation reactions can be reduced.

A binder is added to the CO₂ adsorbent 102b. The binder is provided to hold the CO₂ adsorbent 102b in the working-electrode current collector 102a. The binder has an adhesive force and is provided between the CO₂ adsorbent 102b and the working-electrode current collector 102a.

The binder may be a conductive resin. The conductive resin may be, for example, an epoxy resin or a fluoropolymer, containing Ag or the like as a conductive filler. The fluoropolymer may be, for example, polytetrafluoroethylene (PTFE), or polyvinylidene fluoride (PVDF).

The binder can be brought into contact with the working-electrode current collector 102a containing the CO₂ adsorbent 102b by using an organic solvent such as NMP (N-methylpyrrolidone). Alternatively, a raw material of the binder and the CO₂ adsorbent 102b may be dispersed and mixed using a homogenizer or the like, and then the mixture may be pressure-bonded to the working-electrode current collector 102a or applied as coating to the working-electrode current collector 102a by spraying.

Also as shown in FIG. 3, the counter electrode 103 has the same configuration as the working electrode 102, and is provided with a counter-electrode current collector 103a and a counter-electrode active material 103b.

The counter-electrode current collector 103a may use the same conductive material as the working-electrode current collector 102a, or may use a different material.

The counter-electrode active material 103b is an electroactive species that receives and releases electrons by a redox reaction. The counter-electrode active material 103b may be, for example, a metal complex that can receive and release electrons by changing a valence of a metal ion. Examples of such metal complex include cyclopentadienyl metal complexes such as ferrocene, nickelocene and cobaltocene, and porphyrin metal complexes. In the present embodiment, polyvinyl ferrocene shown below is used as the counter-electrode active material 103b.

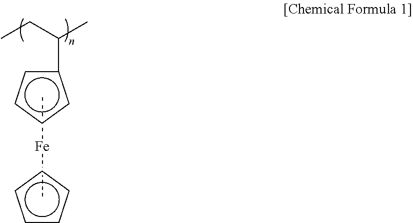

A conductive material and a binder are added to the counter-electrode active material 103b. The conductive material forms a conductive path to the counter-electrode active material 103b. The binder may be any material as long as it can hold the counter-electrode active material 103b on the counter-electrode current collector 103a and has conductivity. The conductive material of the counter electrode 103 may be, for example, a carbon material such as carbon nanotube, carbon black, or graphene. The binder of the counter electrode 103 may use the same material as the working electrode 102, or may use a different material.

The insulating layer 104 is arranged between the working electrode 102 and the counter electrode 103, and is a separator that separates the working electrode 102 and the counter electrode 103 from each other. The insulating layer 104 prevents physical contact between the working electrode 102 and the counter electrode 103 and electrically insulates the working electrode 102 and the counter electrode 103 from each other.

The insulating layer 104 has ion permeability. In the present embodiment, a porous material is used as the insulating layer 104. The insulating layer 104 may be, a cellulose membrane, a polymer, a composite material of a polymer and a ceramic, or the like.

In the electrochemical cell 101, the working electrode 102 and the counter electrode 103 are arranged to sandwich an electrolyte solution 106. The electrolyte solution 106 is an ion conductive material provided between the working electrode 102 and the counter electrode 103. The electrolyte solution 106 is partitioned between the working electrode 102 and the counter electrode 103 by the insulating layer 104.

The electrolyte solution 106 may be, for example, an ionic liquid. The ionic liquid is a salt of a liquid having non-volatility under normal temperature and pressure. When the ionic liquid is used as the electrolyte solution 106, the ionic liquid may be gelled to prevent elution of the ionic liquid from the electrochemical cell 101.

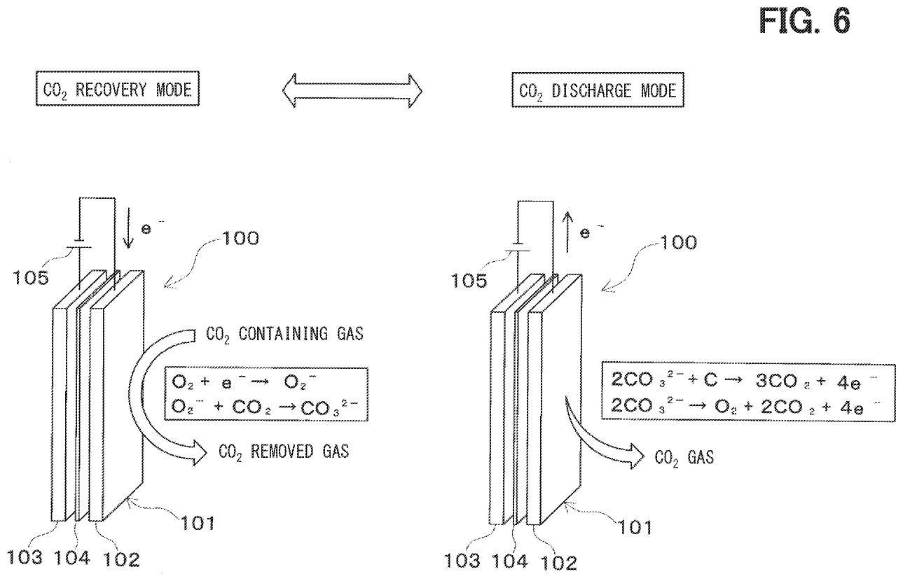

Next, an operation of the carbon dioxide recovery system 10 of the present embodiment will be described. As shown in FIG. 6, the carbon dioxide recovery system operates by alternately switching between the CO₂ recovery mode and the CO₂ discharge mode. The operation of the carbon dioxide recovery system 10 is controlled by the controller 14.

First, the CO₂ recovery mode will be described. In the CO₂ recovery mode, the compressor 11 operates to supply CO₂-containing gas to the CO₂ recovery device 100. In the CO₂ recovery device 100, a voltage applied between the working electrode 102 and the counter electrode 103 is set to the first voltage V1. As a result, the counter-electrode active material 103b of the counter electrode 103 discharges electrons to be oxidized, and the electrons are supplied from the counter electrode 103 to the working electrode 102.

At the working electrode 102, the oxygen reduction reaction producing active oxygen O₂⁻ from the O₂ contained in the CO₂-containing gas, and the carbonate ion generation reaction producing carbonate ions CO₃²⁻ by the active oxygen O₂⁻ oxidizing the CO₂ contained in the CO₂-containing gas proceed. As a result, the CO₂ is adsorbed by the CO₂ adsorbent 102b. Thus, the CO₂ recovery device 100 can recover the CO₂ from the CO₂-containing gas.

In the present embodiment, the oxygen reduction catalyst that promotes the oxygen reduction reaction is added to the CO₂ adsorbent 102b of the working electrode 102. As a result, an electrical energy required for the oxygen reduction reaction can be reduced, and the CO₂ recovery efficiency at the working electrode 102 can be improved.

After the CO₂ is recovered by the CO₂ recovery device 100, the CO₂-removed gas is discharged from the CO₂ recovery device 100. The passage switching valve 12 has switched the passage of exhaust gas to lead to the atmosphere, and the CO₂-removed gas from the CO₂ recovery device 100 is discharged to the atmosphere.

Next, the CO₂ discharge mode will be described. In the CO₂ discharge mode, the compressor 11 is stopped and supply of the CO₂ containing gas to the CO₂ recovery device 100 is stopped. In the CO₂ recovery device 100, a voltage applied between the working electrode 102 and the counter electrode 103 is set to the second voltage V2. As a result, electron donation from the CO₂ adsorbent 102b of the working electrode 102 and electron attraction toward the counter-electrode active material 103b of the counter electrode 103 can be realized at the same time. The counter-electrode active material 103b of the counter electrode 103 receives electrons to be reduced.

The CO₂ adsorbent 102b of the working electrode 102 discharges electrons. By discharging the electrons, the CO₂ adsorbent 102b desorbs adsorbed CO₂. In the CO₂ discharge mode, the carbonate ion dissociation reactions proceed, in which the carbonate ion CO₃²⁻ adsorbed on the CO₂ adsorbent 102b at the working electrode 102 dissociates into CO₂. As a result, the CO₂ is desorbed from the CO₂ adsorbent 102b.

In the present embodiment, the carbonate ion dissociation catalyst that promotes the carbonate ion dissociation reactions is added to the CO₂ adsorbent 102b of the working electrode 102. As a result, an electrical energy required for the carbonate ion dissociation reactions can be reduced, and the CO₂ recovery efficiency at the working electrode 102 can be improved.

The CO₂ released from the CO₂ adsorbent 102b is discharged from the CO₂ recovery device 100. The passage switching valve 12 has switched the passage of the exhaust gas to lead to the CO₂ utilizing device 13, and the CO₂ discharged from the CO₂ recovery device 100 is supplied to the CO₂ utilizing device 13.

In the present embodiment described above, the oxygen reduction catalyst that promotes the oxygen reduction reaction to generate the active oxygen is added to the CO₂ adsorbent 102b of the working electrode 102. As a result, the electrical energy required for the oxygen reduction reaction that triggers the CO₂ adsorption at the working electrode 102 can be reduced, and the CO₂ recovery efficiency at the working electrode 102 can be improved.

Further, in the present embodiment, the carbonate ion dissociation catalyst that promotes the carbonate ion dissociation reactions is added to the CO₂ adsorbent 102b of the working electrode 102. The carbonate ion dissociation reaction is the dissociation of the carbonate ion CO₃²⁻ into CO₂. As a result, the electrical energy required for the carbonate ion dissociation reactions that trigger CO₂ desorption at the working electrode 102 can be reduced, and a CO₂ recovery efficiency at the working electrode 102 can be improved.

### Second Embodiment

Next, a second embodiment of the present disclosure will be described. Hereinafter, differences from the first embodiment will be described.

A CO₂ adsorbent 102b of a second embodiment includes a material having a high specific surface area. The material has promoting function for promoting an oxygen reduction reaction. The material having the high specific surface area may be a metal-organic framework (MOF). The metal-organic framework is a porous body formed by coordination bonding of an organic ligand to a metal ion, and has the high specific surface area. The metal-organic framework having the promoting function for promoting the oxygen reduction reaction may be, for example, Ni₃(HITP)₂. When Ni₃(HITP)₂ is used as the CO₂ adsorbent 102b, the CO₂ adsorbent 102b may be used alone, or a mixture of the CO₂ adsorbent 102b and a binder may be used. In the present embodiment, a redox catalyst and a carbonate ion dissociation catalyst are not added to the CO₂ adsorbent 102b.

According to the second embodiment, as the CO₂ adsorbent 102b, the material with a high specific surface area having the promoting function for promoting the oxygen reduction reaction is used. As a result, the electrical energy required for the oxygen reduction reaction that triggers the CO₂ adsorption at the working electrode 102 can be reduced, and the CO₂ recovery efficiency at the working electrode 102 can be improved.

### OTHER EMBODIMENTS

The present disclosure is not limited to the embodiments described hereinabove, but may be modified in various ways as hereinbelow without departing from the gist of the present disclosure. The means disclosed in the individual embodiments may be appropriately combined as long as the combination is feasible.

For example, in the first embodiment, both the oxygen reduction catalyst and the carbonate ion dissociation catalyst are added to the CO₂ adsorbent 102b, but the configuration is not limited to this. Only one of the oxygen reduction catalyst and the carbonate ion dissociation catalyst may be added to the CO₂ adsorbent 102b.

Further, in the first embodiment, the carbonate ion dissociation catalyst is added to the CO₂ adsorbent 102b, but a material having a function for promoting the carbonate ion dissociation reactions may be used for the CO₂ adsorbent 102b.

Further, in the second embodiment, the material having the oxygen reduction reaction promoting function, and the oxygen reduction catalyst or the carbonate ion dissociation catalyst may be used at the same time.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A carbon dioxide recovery system that separates CO₂ from gas containing CO₂ via an electrochemical reaction, the carbon dioxide recovery system comprising:
an electrochemical cell including a working electrode and a counter electrode, the working electrode including a CO₂ adsorbent, wherein
the CO₂ adsorbent is configured to adsorb CO₂ via an oxygen reduction reaction by using electrons supplied from the counter electrode to the working electrode when a first voltage is applied between the working electrode and the counter electrode, the oxygen reduction reaction producing active oxygen via reduction of O₂,
the CO₂ adsorbent is configured to desorb CO₂ by discharging electrons from the working electrode to the counter electrode when a second voltage different from the first voltage is applied between the working electrode and the counter electrode, and
the CO₂ adsorbent has a promoting function for promoting the oxygen reduction reaction.

2. The carbon dioxide recovery system according to claim 1, wherein
the CO₂ adsorbent contains an oxygen reduction catalyst that promotes the oxygen reduction reaction.

3. The carbon dioxide recovery system according to claim 2, wherein
the oxygen reduction catalyst includes at least one of Pt, RuO₂ or perovskite type oxides.

4. The carbon dioxide recovery system according to claim 1, wherein
the CO₂ adsorbent includes a high specific surface area material having the promoting function for promoting the oxygen reduction reaction.

5. The carbon dioxide recovery system according to claim 4, wherein
the high specific surface area material is Ni₃(HITP)₂.

6. The carbon dioxide recovery system according to claim 1, wherein
the CO₂ adsorbent desorbs CO₂ via a carbonate ion dissociation reaction when the second voltage is applied between the working electrode and the counter electrode, the carbonate ion dissociation reaction producing CO₂ from CO₃²⁻ via dissociation of CO₂, and
the CO₂ adsorbent has a promoting function for promoting the carbonate ion dissociation reaction.

7. A carbon dioxide recovery system that separates CO₂ from gas containing CO₂ via an electrochemical reaction, the carbon dioxide recovery system comprising:
an electrochemical cell including a working electrode and a counter electrode, the working electrode including a CO₂ adsorbent, wherein
the CO₂ adsorbent is configured to adsorb CO₂ by using electrons supplied from the counter electrode to the working electrode when a first voltage is applied between the working electrode and the counter electrode,
the CO₂ adsorbent is configured to desorb CO₂ via a carbonate ion dissociation reaction by discharging electrons from the working electrode to the counter electrode when a second voltage is applied between the working electrode and the counter electrode, the carbonate ion dissociation reaction producing CO₂ from CO₃²⁻ via dissociation of CO₂, and
the CO₂ adsorbent has a promoting function for promoting the carbonate ion dissociation reaction.

8. The carbon dioxide recovery system according to claim 7, wherein
the CO₂ adsorbent contains a carbon ion dissociation catalyst that promotes the carbonate ion dissociation reaction.

9. The carbon dioxide recovery system according to claim 8, wherein
the carbon ion dissociation catalyst includes at least one of RuO₂, IrO₂, Mn or Mn₂C.
